(19) United States
(12) Patent Application Publication
(10) Pub. No.: US 2026/0250201 A1
(43) Pub. Date: Aug. 27, 2026

(54) BIONIC SUPERHYDROPHOBIC POROUS CERAMIC FOR PLANTING PLANTS UNDER WATER AND PREPARATION METHOD THEREOF

(71) Applicant: Yuxuan ZHANG, Suzhou (CN)

(72) Inventors: Lei DONG, Suzhou (CN); Yuxuan ZHANG, Singapore (SG)

(21) Appl. No.: 19/061,747

(22) Filed: Feb. 24, 2025

(51) Int. Cl. C04B 35/10; A01G 31/02; C04B 38/00; C04B 41/00; C04B 41/45; C04B 41/49

(52) U.S. Cl. CPC C04B 35/10; A01G 31/024; C04B 38/0038; C04B 38/0054; C04B 38/0074; C04B 41/0063; C04B 41/0072; C04B 41/457; C04B 41/4961; C04B 2235/3217; C04B 2235/3418; C04B 2235/445; C04B 2235/5228; C04B 2235/6562; C04B 2235/96

(57) ABSTRACT

The present disclosure provides a bionic superhydrophobic porous ceramic for planting plants under water and a preparation method thereof. The ceramic comprises: aluminum oxide powder; silica; and aluminum fluoride. The preparation method comprises: mixing and milling aluminum oxide powder, silica and aluminum fluoride; after milling, adding the sample with water to prepare a slurry, and pouring the slurry into a mold to form a porous ceramic green body; drying the porous ceramic green body, heating at 1100° C.-1500° C., and then cooling to obtain the bionic superhydrophobic porous ceramic with a mullite whisker structure; immersing the porous ceramic with the mullite whisker structure in 1-5 wt % n-hexane solution of polydimethylsiloxane, and then heating at 100° C.-500° C. to obtain the bionic superhydrophobic porous ceramic.

### TECHNICAL FIELD

The present disclosure belongs to the technical field of new materials, in particular to a bionic superhydrophobic porous ceramic for planting plants under water and preparation method thereof.

### BACKGROUND

With the acceleration of global industrialization and urbanization, climate problems such as global warming and sea level rise caused by CO₂ emissions have become increasingly serious. These changes have also brought about the shortage of fresh water resources and the reduction of arable land. The earth's oceans account for more than 70% of the total area. The oceans absorb 30% of the CO₂ emitted into the atmosphere. One billion tons of CO₂ enter the oceans every year, causing serious marine environmental problems such as seawater acidification, deterioration of the living environment of marine organisms, and destruction of coral reefs. At the same time, the high heat capacity and moderate temperature of seawater provide an ideal temperature environment for plant growth. Therefore, directly using the water, air, light, heat and other conditions of the ocean to plant plants under the sea level can not only alleviate the current food and vegetable supply problem, but also help carbon neutralization, providing new solutions for CO₂ solidification and acidification of seawater.

The areas with scarce cultivated land in the world are in urgent need of alternative planting methods, and the underwater area is a vast area that has not been developed. L. Pistelli, et al. for the first time tried to grow vegetables in transparent closed containers under the sea, which is called the Nemo's Garden (L. Pistelli, et al. Growing basil in the underwater biospheres of Nemo's Garden: Phytochemical, physiological and micromorphological analyses. Scientia Horticulturae, 2020, 259: 108851). However, Nemo's Garden only uses the marine space environment, light and temperature conditions, and cannot directly use seawater and dissolved O₂ and CO₂ gas to support plant growth. Water vapor, O₂ and CO₂ can only be supplied by artificial reconstruction, such as electric heating and distillation of seawater. The nutrient solution is used for irrigation every one to two days. Therefore, Nemo's Garden is a closed system with seawater, which can not solve the problem of CO₂ solidification in seawater, and is expensive and difficult to promote. So far, no successful case of directly using seawater and dissolved gases in seawater for underwater cultivation of crops has been reported.

In order to solve the problem of the growth of terrestrial plants in seawater, the key is to solve the photosynthesis and underwater gas exchange of plants, and how to use seawater for the growth of crops. The realization of illumination can rely on the assistance of transparent materials such as glass to ensure sufficient illumination. Nemo's Garden has tried to meet the requirements of light and temperature, which shows that the marine environment can meet the needs of light and heat. The greater challenge is how to maintain photosynthesis and gas exchange of crops in the underwater environment, that is, the problem of water and gas. Some plants, such as lotus, rice and aquatic plants along the river, will be submerged by floods, which can last for several days without death. Colmer and Pedersen's research on wetland plants found that the leaves of these plants have hydrophobic properties, and the leaf surface has a porous hydrophobic and breathable membrane. When these leaves are submerged in water, the gas in the water is easy to accumulate at the interface between the leaves and water to form a gas film. Through this gas film, plants can exchange gas with O₂ and CO₂ dissolved in water to maintain photosynthesis (Timothy D, Ole P. underwater photosynthesis and respiration in leaves of submerged wetland plants: gas films improve CO₂ and O₂ exchange. New phytologist(2008)177: 918-926). Pedersen et al. found that rice can survive the flood, and when rice completely submerged in water, it can still rely on the hydrophobic and breathable membrane on the leaf surface to exchange gas with dissolved O₂ and CO₂ in water to maintain photosynthesis (Pedersen, O., rich, S. M. and Colmer, T. D. (2009), surviving floods: leaf gas films improve O₂ and CO₂ exchange, root aeration, and growth of completely submerged rice. The Plant Journal, 58:147-156). Winkel et al. found that the leaf gas film of Spartina anglica enhanced the oxygen supply to the rhizome and root during tidal immersion (Winkel, A. Colmer, T. D. and Pedersen, O. (2011), leaf gas films of Spartina anglica enhance rhome and root oxygen during tidal submergence Plant, Cell & Environment, 34:2083-2092). Kurokawa et al. revealed that the hydrophobicity and gas membrane of rice leaves are endowed by a wax synthesis gene (LGF1) and contribute to its flood resistance, and proposed that wheat and other crops can form hydrophobic and breathable membranes through transgenic methods to improve the flood resistance of agricultural plants (Kurokawa, Y., Nagai, K., Huan, P. D., Shimazaki, K., Qu, H., Mori, Y., Toda, Y., Kuroha, T., Hayashi, N., Aiga, S., Itoh, J.-i., Yoshimura, A., Sasaki-Sekimoto, Y., Ohta, H., Shimojima, M., Malik, A. I., Pedersen, O., Colmer, T. D. and Ashikari, M. (2018), Rice leaf hydrophobicity and gas films are conferred by a wax synthesis gene (LGF1) and contribute to flood tolerance. New Phytol, 218:1558-1569.). Zhao et al. Studied the micro morphology of the hydrophobic surface of lotus leaf. The reason why lotus leaf can form hydrophobic gas film under water is the micro nano structure of the surface (F. Zhao, F. Zhan, L. Wang, hybrid topology of lotus leaf under hydrostatic/hydrodynamic pressure. adv. mater. interfaces 2023, 10, 220, 2044). At present, there is no literature report on the artificial synthesis of plant hydrophobic and breathable membrane for plant underwater gas exchange based on the principle of bionics.

### SUMMARY

The leaves of a few plants, such as lotus and rice, are hydrophobic and aerophilic. When the leaves are immersed in water, they can form a gas film on the surface. Plants exchange gas through the gas film to carry out photosynthesis and respiration under water, so that life activities can be maintained under water. The purpose of the present disclosure is to bionically utilize the principle to make superhydrophobic porous ceramic and apply them to the underwater survival of terrestrial plants.

One of the objects of the present disclosure is to provide a bionic superhydrophobic porous ceramic for planting plants under water, wherein the bionic superhydrophobic porous ceramic comprises:
aluminum oxide powder;
silica; and
aluminum fluoride;
the bionic superhydrophobic porous ceramic has a mullite component, and the bionic superhydrophobic porous ceramic has a grass-cluster porous body with mullite whisker microstructure;
the bionic superhydrophobic porous ceramic has a porosity of 57%-80%, a pore size of 0.2 μm-1.37 μm, a bending strength of 4-53 MPa, and a contact angle of 152°-170°.

In one embodiment, wherein the mass percentage between the aluminum oxide powder, the silica and the aluminum fluoride is (70-72): (25-28): (1-3).

In one embodiment, wherein the bionic superhydrophobic porous ceramic is hydrophobic and breathable underwater to form a gas film, and the gas film is configured to collect dissolved gas or bubbles in water to supply plants.

The second object of the present disclosure is to provide a method for preparing bionic superhydrophobic porous ceramic for planting plants under water, wherein the method comprises:
mixing and milling aluminum oxide powder, silica and aluminum fluoride with mass percentages of 70%-72%, 25%-28% and 1%-3% to get a sample;
after milling, adding the sample with water to prepare a slurry, and pouring the slurry into a mold for curing to form a porous ceramic green body;
drying the porous ceramic green body, heating at 1100° C.-1500 ° C., and then cooling to obtain the bionic superhydrophobic porous ceramic with a mullite whisker structure;
immersing the porous ceramic with the mullite whisker structure in 1-5 wt % n-hexane solution of polydimethylsiloxane, and then heating at 100° C.-500 ° C. to obtain the bionic superhydrophobic porous ceramic.

In one embodiment, wherein the steps of drying the porous ceramic green body, heating at 1100° C.-1500° C., and then cooling to obtain the bionic superhydrophobic porous ceramic with a mullite whisker structure are carried out in the following environment: temperature rise conditions: 30-600° C., temperature rise rate of 5° C./min, 600° C. with temperature rise rate of 3° C./min.

The third object of the present disclosure is to provide the use of the bionic superhydrophobic porous ceramic. The prepared high-performance hydrophobic ceramics are used for underwater planting. The leaves of lotus and rice have a hydrophobic structure. The hydrophobic structure of plant leaves forms a leave film gas under the water. The gas film can enrich the underwater gas and supply the plants with underwater breathing, so that the plants can resist waterlogging and will not be flooded. Inspired by this natural phenomenon, the bionic hydrophobic porous ceramics are developed for underwater planting of plants.

The bionic superhydrophobic porous ceramic for planting plants under water use the principle that the hydrophobic leaves of lotus leaf enrich gas under water and maintain life activities. The artificial bionic superhydrophobic porous ceramic are suitable for the planting plants under water.

More embodiments of the present disclosure can also realize other advantageous technical effects not listed one by one. These other technical effects may be described in part below, and can be expected and understood by those skilled in the art after reading the present disclosure.

### BRIEF DESCRIPTION OF THE DRAWINGS

FIG. 1 is figures of the superhydrophobic porous ceramic prepared in embodiment 1 and its contact angle, wherein (a) left is the porous body before sintered and (a) right is the porous body after sintered; (b) is the water contact angle measured.

FIG. 2 is the X-ray diffraction pattern (XRD) of the porous ceramics prepared in embodiment 1 under different temperatures from 750-1100° C.

FIG. 3 is the scanning electron microscope (SEM) figure of the porous ceramics prepared in embodiment 1 under different temperatures, wherein (a) 750° C.,(b) 900° C., (c) 1000° C., and (d) 1100° C.

FIG. 4 shows the pore size distribution of the porous ceramics prepared in embodiment 1.

FIG. 5 shows the use of the super hydrophobic porous ceramics in underwater plant planting, wherein (a) rose,(b) tomato,(c) sweet potatoes and pumpkin.

FIG. 6 shows: (a) and (b) surface morphology of the material after hydrophobic modification; (c) the material forms a gas film under water; and (d) bubbles formed by gas exchange on the surface of the material.

### DETAILED DESCRIPTION OF THE EMBODIMENTS

The phrases and terms used in the present disclosure are for descriptive purposes and should not be considered restrictive. The use of “include”, “including” or “have” and their variants in the present disclosure is intended to include the items listed below and their equivalents as well as additional items in an open manner.

As the term “mullite” used in the present disclosure refers to a series of minerals composed of aluminosilicates.

### Embodiment 1

A method for preparing superhydrophobic porous ceramic comprises:
Step 1, mixing ρ-aluminum oxide powder, silica and aluminum fluoride with mass percentages of 72%, 27% and 1%, respectively, and then milling for 4 hours, with a milling medium of agate, and a ball mill speed of 350 rpm;
Step 2, adding the milled sample with water to prepare a slurry with a solid content of 50%-88%, and pouring the slurry into the mold for curing to obtain a porous ceramic green body;
Step 3, drying the porous ceramic green body, heating at 1100° C. for 2 hours, and cooling in the furnace to obtain the bionic superhydrophobic porous ceramic with a mullite whisker structure, and the heating conditions are: 30-600° C., the heating rate is 5° C./min, and the heating rate at 600° C. is 3° C./min;
Step 4, immersing the porous ceramic with the mullite whisker structure in the n-hexane solution of polydimethylsiloxane with a concentration of 3 wt %, and then heating at 100° C. to obtain the superhydrophobic porous ceramic.

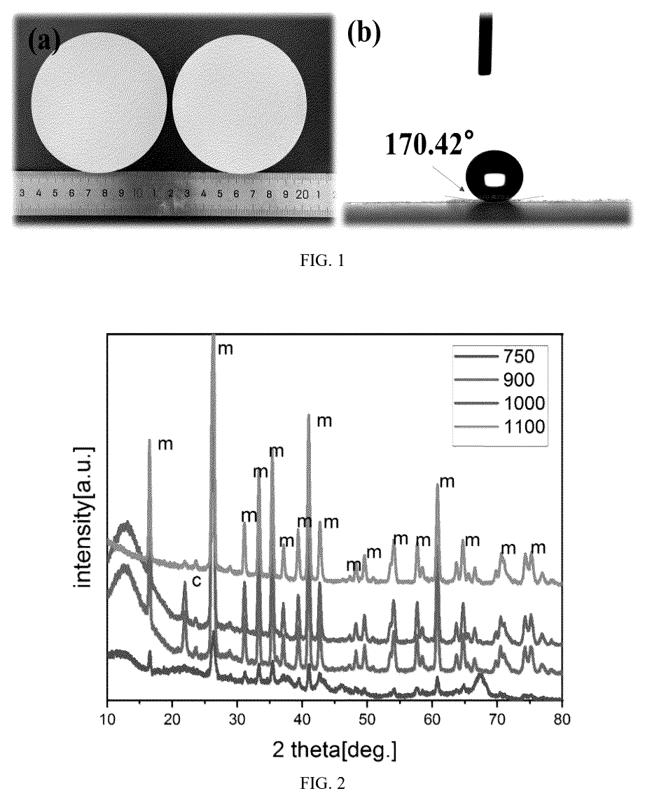

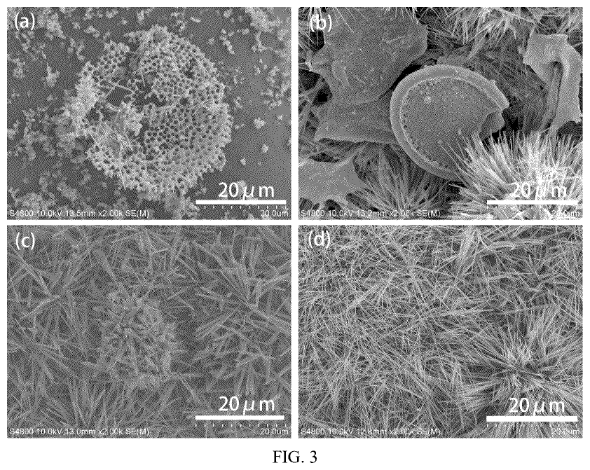

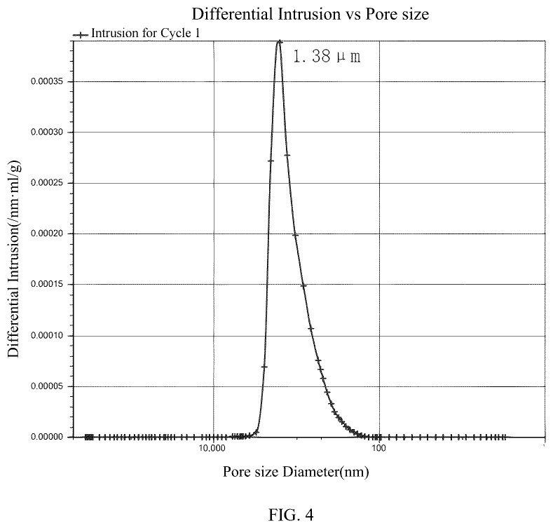

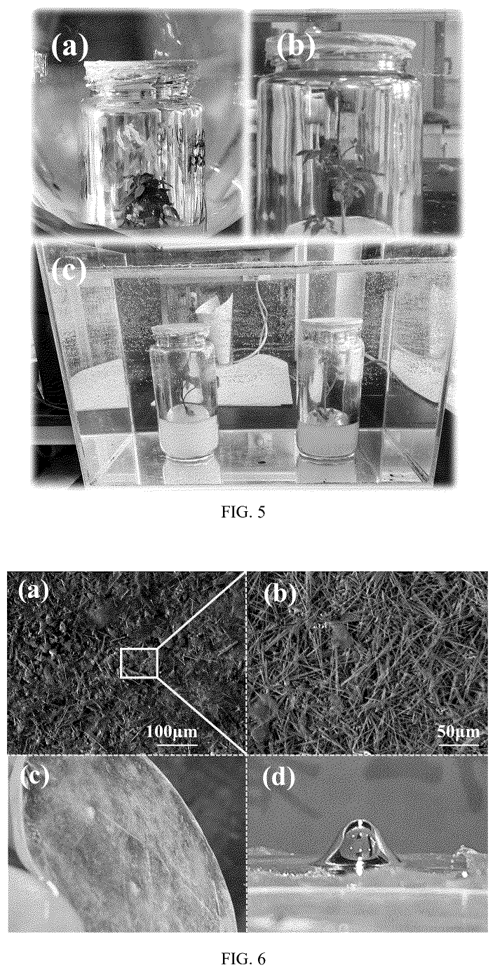

The prepared superhydrophobic porous ceramics are shown in FIG. 1, the contact angle is 170 °, the composition of the porous ceramic is shown in FIG. 2, and it is mullite by X-ray diffraction. The microstructure is shown in FIG. 3 by scanning electron microscope. It is a grass-cluster porous body structured by mullite whiskers, with a porosity of 80%. The pore size is measured as 1.38 μm by mercury intrusion method in FIG. 4, and the bending strength of the porous ceramic is 4 MPa. The figure of super hydrophobic porous ceramics used for underwater plant planting is shown in FIG. 5. Roses, tomatoes, sweet potatoes, pumpkins and other plants grow normally underwater.

### Embodiment

2

A method for preparing superhydrophobic porous ceramic comprises:
Step 1, mixing ρ-aluminum oxide powder, silica and aluminum fluoride with mass percentages of 70%, 28% and 2%, respectively, and then milling for 4 hours, with a milling medium of agate, and a ball mill speed of 350 rpm;
Step 2, adding the milled sample with water to prepare a slurry with a solid content of 60%, and pouring the slurry into the mold for curing to obtain a porous ceramic green body;
Step 3, drying the porous ceramic green body, heating at 1200° C. for 2 hours, and cooling in the furnace to obtain the bionic superhydrophobic porous ceramic with a mullite whisker structure, and the heating conditions are: 30-600° C., the heating rate is 5° C./min, and the heating rate at 600° C. is 3° C. /min;

Step 4, immersing the porous ceramic with the mullite whisker structure in 1 wt % n-hexane solution of polydimethylsiloxane, and then heating at 500° C. to obtain the bionic superhydrophobic porous ceramic.

The prepared superhydrophobic porous ceramic are composed of mullite, and the microstructure is a grass-like porous body with mullite whisker structure. The porosity is 72%, the pore size is 1 μm, the contact angle is 162°, and the bending strength of the porous ceramic is 6 MPa. As shown in FIG. 6, the prepared superhydrophobic porous ceramic can form a gas film under water, which is hydrophobic and breathable. The superhydrophobic porous ceramic are used for underwater plant planting, and plants can grow normally under water.

### Embodiment 3

A method for preparing superhydrophobic porous ceramic comprises:
Step 1, mixing ρ-aluminum oxide powder, silica and aluminum fluoride with mass percentages of 72%, 26% and 2%, respectively, and then milling for 4 hours, with a milling medium of agate, and a ball mill speed of 350 rpm;
Step 2, adding the milled sample with water to prepare a slurry with a solid content of 70%, and pouring the slurry into the mold for curing to obtain a porous ceramic green body;
Step 3, drying the porous ceramic green body, heating at a high temperature of 1300° C. for 2 hours, and cooling in the furnace to obtain the bionic superhydrophobic porous ceramic with a mullite whisker structure, and the heating conditions are: 30-600° C., the heating rate is 5° C./min, and the heating rate at 600° C. is 3° C./min;
Step 4, immersing the porous ceramic with mullite whisker structure in n-hexane solution of polydimethylsiloxane with a concentration of 2 wt %, and then heating at 400° C. to obtain the bionic superhydrophobic porous ceramic.

The component of the superhydrophobic porous ceramic is mullite, and the microstructure is grass-like porous body with mullite whisker structure. The porosity is 68%, the pore size is 0.8 μm, the contact angle is 158°, and the bending strength of the porous ceramic is 16 MPa. The superhydrophobic porous ceramic are used for planting plants under water, and plants can grow normally under water.

### Embodiment 4

A method for preparing superhydrophobic porous ceramic comprises:
Step 1, mixing ρ-aluminum oxide powder, silica and aluminum fluoride with mass percentages of 70%, 27% and 3%, respectively, and then milling for 4 hours, with a milling medium of agate, and a ball mill speed of 350 rpm;
Step 2, adding the milled sample with water to prepare a slurry with a solid content of 80%, and pouring the slurry into the mold for curing to obtain a porous ceramic green body;
Step 3, drying the porous ceramic green body, heating at 1400° C. for 2 hours, and cooling in the furnace to obtain the bionic superhydrophobic porous ceramic with a mullite whisker structure, and the heating conditions are: 30-600° C., the heating rate is 5° C./min, and the heating rate at 600° C. is 3° C./min;
Step 4, immersing the porous ceramic with the mullite whisker structure in a n-hexane solution of polydimethylsiloxane with a concentration of 4 wt %, and then heating at 300° C. to obtain the superhydrophobic porous ceramic.

The component of the superhydrophobic porous ceramic is mullite, and the microstructure is grass-like porous body with mullite whisker structure. The porosity is 63%, the pore size is 0.5 μm, the contact angle is 155°, and the bending strength of the porous ceramic is 32 MPa. The superhydrophobic porous ceramic are used for planting plants under water, and plants can grow normally under water.

### Embodiment 5

A method for preparing superhydrophobic porous ceramic comprises:
Step 1, mixing ρ-aluminum oxide powder, silica and aluminum fluoride with mass percentages of 72%, 25% and 3%, respectively, and then milling for 4 hours, with a milling medium of agate, and a ball mill speed of 350 rpm;
Step 2, adding the milled sample with water to prepare a slurry with a solid content of 80%, and pouring the slurry into the mold for curing to obtain a porous ceramic green body;
Step 3, drying the porous ceramic green body, heating at 1500° C. for 2 hours, and cooling in the furnace to obtain the bionic superhydrophobic porous ceramic with a mullite whisker structure, and the heating conditions are: 30-600° C., the heating rate is 5° C./min, and the heating rate at 600° C. is 3° C./min;
Step 4, immersing the porous ceramic with the mullite whisker structure in a n-hexane solution of polydimethylsiloxane with a concentration of 5 wt %, and then heating at 200° C. to obtain the superhydrophobic porous ceramic.

The component of the superhydrophobic porous ceramic is mullite, and the microstructure is grass-like porous body with mullite whisker structure. The porosity is 57%, the pore size is 0.2 μm, the contact angle is 152°, and the bending strength of the porous ceramic is 53 MPa. The superhydrophobic porous ceramic are used for underwater plant planting, and plants can grow normally under water.

What is claimed is:

1. A bionic superhydrophobic porous ceramic for planting plants under water, wherein the bionic superhydrophobic porous ceramic comprises:
aluminum oxide powder;
silica; and
aluminum fluoride;
the bionic superhydrophobic porous ceramic has a mullite component, and the bionic superhydrophobic porous ceramic has a grass-cluster porous body with mullite whisker microstructure;
the bionic superhydrophobic porous ceramic has a porosity of 57%-80%, a pore size of 0.2 μm-1.37 μm, a bending strength of 4-53 MPa, and a contact angle of 152°-170°.

2. The bionic superhydrophobic porous ceramic for planting plants under water according to claim 1, wherein the mass percentage between the aluminum oxide powder, the silica and the aluminum fluoride is (70-72): (25-28): (1-3).

3. The bionic superhydrophobic porous ceramic for planting plants under water according to claim 2, wherein the bionic superhydrophobic porous ceramic is hydrophobic and breathable underwater to form a gas film, and the gas film is configured to collect dissolved gas or bubbles in water to supply plants.

4. A method for preparing bionic superhydrophobic porous ceramic for planting plants under water, wherein the method comprises:
mixing and milling aluminum oxide powder, silica and aluminum fluoride with mass percentages of 70%-72%, 25%-28% and 1%-3% to get a sample;
after milling, adding the sample with water to prepare a slurry, and pouring the slurry into a mold for curing to form a porous ceramic green body;
drying the porous ceramic green body, heating at 1100° C.-1500° C., and then cooling to obtain the bionic superhydrophobic porous ceramic with a mullite whisker structure;
immersing the porous ceramic with the mullite whisker structure in 1-5 wt % n-hexane solution of polydimethylsiloxane, and then heating at 100° C.-500° C. to obtain the bionic superhydrophobic porous ceramic.

5. The method for preparing the bionic superhydrophobic porous ceramic for planting plants under water according to claim 4, wherein the steps of drying the porous ceramic green body, heating at 1100° C.-1500° C., and then cooling to obtain the bionic superhydrophobic porous ceramic with a mullite whisker structure are carried out in the following environment: temperature rise conditions: 30-600° C. , temperature rise rate of 5° C./min, 600° C. with temperature rise rate of 3° C./min.
